(19) United States
(12) Patent Application Publication
(10) Pub. No.: US 2006/0065083 A1
(43) Pub. Date: Mar. 30, 2006

(54) Driving tool attaching device

(76) Inventor: Eric Liao, Taichung (TW)

Correspondence Address: Eric LIAO, P.O. Box 63-298, Taichung, 406, TW

(21) Appl. No.: 10/949,772

(22) Filed: Sep. 27, 2004

(51) Int. Cl. B25B 13/46; B25B 23/00

(52) U.S. Cl. 81/438; 81/437; 81/439; 81/60

(57) ABSTRACT

A driving tool attaching device includes a handle having two plates secured together and disposed parallel to each other and each having a tool retainer, the tool retainers include an engaging depression to receive a tool element. A sleeve is slidably engaged onto the tool retainers, and movable relative to the tool retainers, to retain the tool retainers together, and to prevent the tool retainers from being moved away from each other, and to solidly retain the tool element between the tool retainers. A spacer may be secured between the plates, to space the plates from each other. The handle may include a tool driving member for driving fasteners.

### BACKGROUND OF THE INVENTION

1. Field of the Invention

The present invention relates to a driving tool attaching device, and more particularly to a driving tool attaching device having a movable and resilient retaining sleeve for solidly coupling tool members to a driving shank of a driving tool.

2. Description of the Prior Art

Typical driving tools comprise one or more tool extensions, tool bits, sockets, or other tool members that are required to be attached or coupled to a primary driving tool shank with various kinds of attaching devices, for engaging with and for driving fasteners with the tool members.

For example, U.S. Pat. No. 4,502,365 to Hacker discloses one of the typical socket wrench extensions including a socket detachably attached or secured to a shaft with a slide pin. However, it is difficult and expensive to form a tiny orifice in the shaft and to receive the slide pin within the tiny orifice.

U.S. Pat. No. 4,535,658 to Molinari discloses another typical socket bit holder including a tool bit to be detachably attached or secured to a socket with a split ring. However, the socket is required to form a circumferential groove therein to receive the split ring, such that the strength of the socket will be decreased.

U.S. Pat. No. 4,781,085 to Fox, III discloses a further typical locking socket wrench extension including a socket detachably attached or secured to a shaft with a detent ball. However, it is also difficult and expensive to form a tiny orifice in the shaft and to receive the slide pin within the tiny orifice.

U.S. Pat. No. 4,962,682 to Rose et al. discloses a still further typical wrench extension and socket coupler including a shaft having a longitudinal cavity formed therein for receiving a number of balls and an actuator. However, it is also difficult and expensive to form the longitudinal cavity in the shaft and to receive the balls and the actuator within the longitudinal cavity.

U.S. Pat. No. 6,154,108 to Huang discloses a still further typical fastener attaching device for tool which includes a socket type body member having a detent ball slidably received therein and forcible toward a tool bit with a retaining ring, in order to detachably couple the socket type body member to the tool bit. However, it is also difficult and expensive to form an aperture in the body and to receive the ball within the aperture of the body.

The present invention has arisen to mitigate and/or obviate the afore-described disadvantages of the conventional driving tool attaching devices.

### SUMMARY OF THE INVENTION

The primary objective of the present invention is to provide a driving tool attaching device including a movable and resilient retaining sleeve for solidly coupling tool members to a driving shank of a driving tool.

In accordance with one aspect of the invention, there is provided a driving tool attaching device comprising a handle including two plates secured together and disposed parallel to each other, and each plate including a tool retainer extended therefrom and having a depression formed therein, the tool retainers being disposed parallel to each other and spaced away from each other, and the depressions of the tool retainers form an engaging depression to receive a tool element therein, and a sleeve slidably engaged onto the tool retainers, and movable relative to the tool retainers, to retain the tool retainers together, and to prevent the tool retainers from being moved away from each other, and to solidly retain the tool element between the tool retainers.

Each of the tool retainers includes two side flaps extended therefrom and inclined relative to the tool retainers, to form a trapezoid depression therein, and to form the engaging depression in the tool retainers. The sleeve includes a peripheral flange extended outwardly therefrom to form as a hand grip, and to facilitate moving of the sleeve along the tool retainers.

A spacer may further be provided and disposed and secured between the plates, to space the plates from each other. The spacer includes two side panels extended therefrom to form two recesses in upper and bottom portions thereof, and to receive the plates respectively, and to anchor the spacer between the plates. The spacer may include a cavity formed therein for receiving a spring biased projection.

The handle includes a tool driving member attached thereto, for driving fasteners. The tool driving member includes a barrel rotatably engaged in the handle and having an engaging hole formed therein for receiving the fasteners.

The tool driving member includes a gear disposed on an outer peripheral portion of the barrel, a pawl rotatably secured to the handle with a pivot pin, and a spring biased projection engaged with the pawl, to force the pawl to engage with the gear, and to determine a driving direction of the driving member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a driving tool attaching device in accordance with the present invention;

FIG. 2 is a partial exploded view of the driving tool attaching device;

FIG. 3 is a perspective view of the driving tool attaching device;

FIG. 4 is a partial cross sectional view of the driving tool attaching device, taken along lines 4-4 of FIG. 3; and

FIG. 5 is a partial cross sectional view similar to FIG. 4, illustrating the operation of the driving tool attaching device.

### DETAILED DESCRIPTION OF THE PREFERRED EMBODIMENT

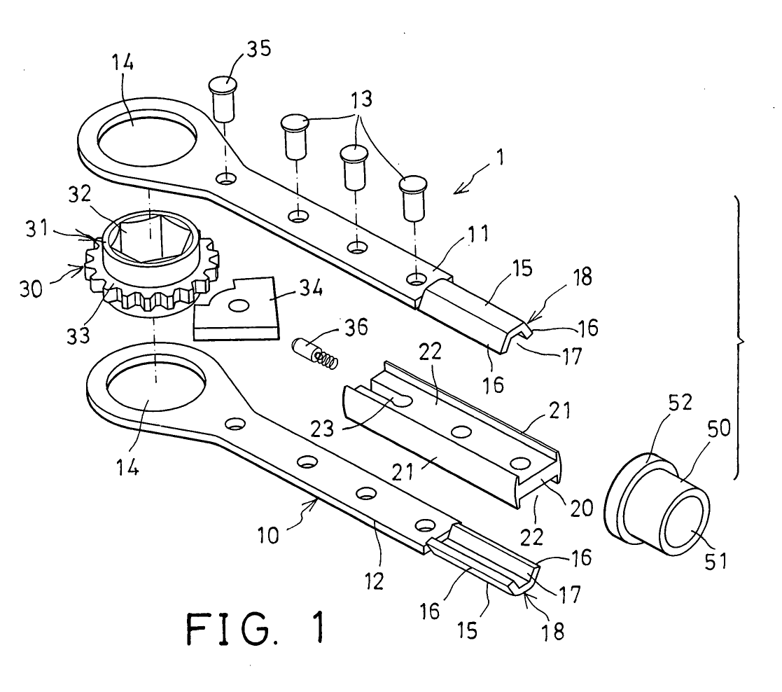

Referring to the drawings, and initially to FIGS. 1-4, a driving tool attaching device 1 in accordance with the present invention comprises a handle 10 including two longitudinal plates 11, 12 disposed parallel to each other, and secured together by fasteners 13, such as bolts, rivets, or the like. Each of the longitudinal plates 11, 12 may include an opening 14 formed in one end thereof, and may include a tool retainer 15 attached or provided on or extended from the other end thereof.

It is preferable that a spacer 20 is disposed between the plates 11, 12, and secured between the plates 11, 12 with the fasteners 13, to suitably space the plates 11, 12 and the tool retainers 15 away from each other. The spacer 20 includes two side panels 21 extended from two sides thereof and perpendicular to the spacer 20, to form two recesses 22 in the upper and in the bottom portions thereof, and for receiving the plates 11, 12 respectively, to solidly anchor the spacer 20 between the plates 11, 12.

A tool driving member 30 is attached to one end of the handle 10, and includes a barrel 31 rotatably engaged in the openings 14 of the handle 10 and having an engaging hole 32 formed therein for receiving sockets, fasteners, tool extensions or other tool elements, and includes a gear 33 disposed on an outer peripheral portion of the barrel 31 and retained between the plates 11, 12.

A pawl 34 is rotatably secured to the handle 10 with a pivot pin 35, and a spring biased projection 36 received in a cavity 23 that is formed in the spacer 20. The spring biased projection 36 is engageable with the pawl 34, to force the pawl 34 to engage with the gear 33 of the driving member 30, and to determine the driving direction of the driving member 30. The driving member 30 and the pawl 34 are typical and will not be described in further details.

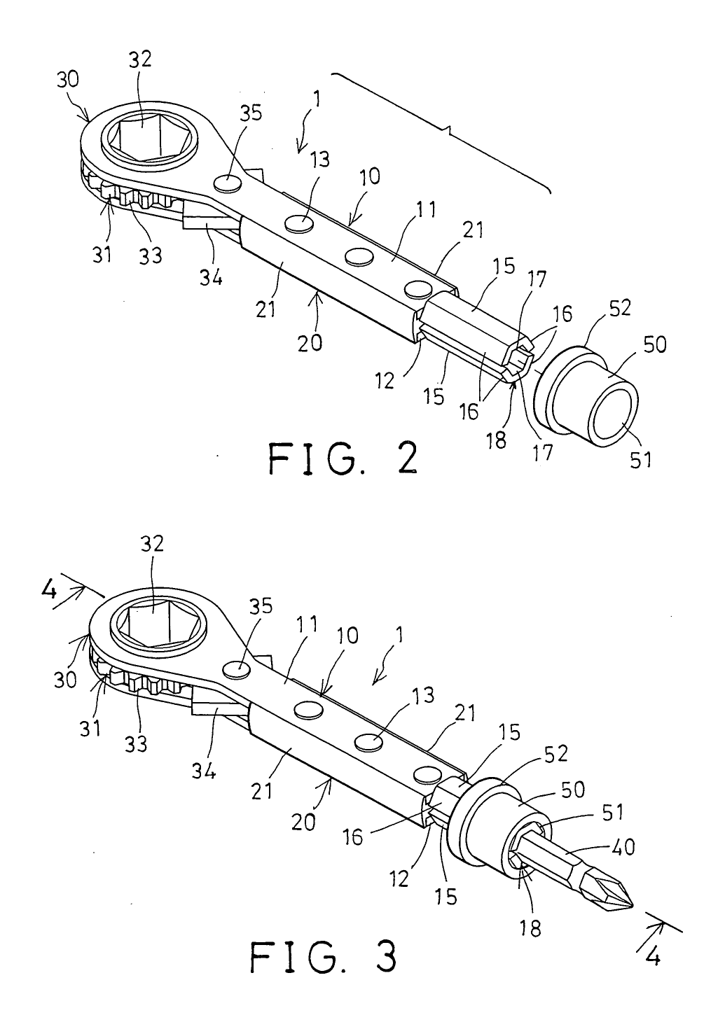

The tool retainers 15 of the plates 11, 12 each includes two side flaps 16 extended therefrom and inclined relative to the tool retainers 15, to form or define a substantially trapezoid depression 17 therein. The tool retainers 15 are also disposed parallel to each other but spaced away from each other, and the trapezoid depressions 17 of the tool retainers 15 may, together, form or define a substantially hexagonal or engaging depression 17 (FIG. 2) to receive a tool element 40 therein, such as a screw driver bit 40.

As best shown in FIGS. 2-5, the tool retainers 15 of the plates 11, 12 are spaced away from each other, for allowing the tool element 40 to be easily engaged into the trapezoid depressions 17 of the tool retainers 15 or the hexagonal depression 17 of the handle 10, and for allowing the other tool elements 40 of different diameters to be selectively engaged into the trapezoid depressions 17 of the tool retainers 15 or the hexagonal depression 17 of the handle 10. The tool retainers 15 that are spaced away from each other may be slightly moved toward and away from each other to allow tool elements 40 of different diameters to be attached thereto.

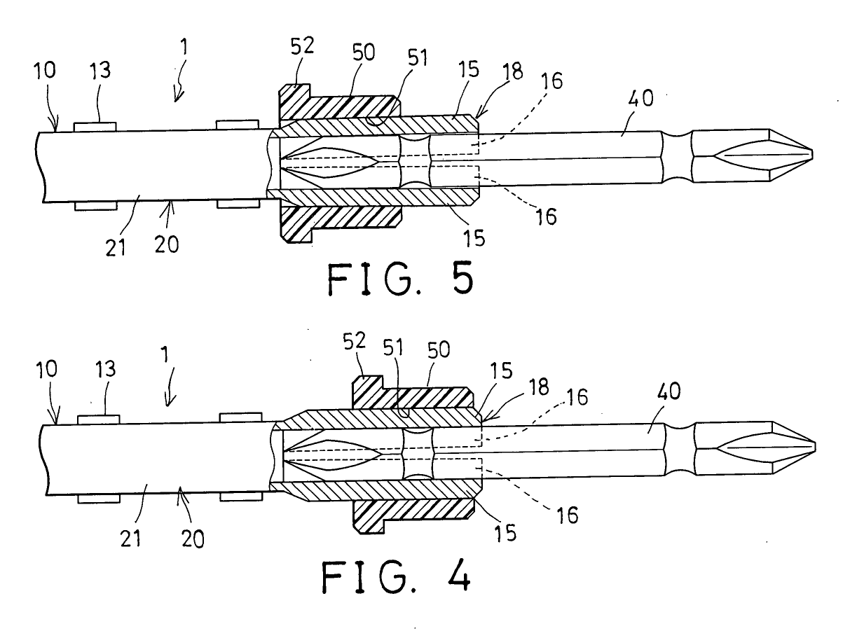

The driving tool attaching device 1 further includes a resilient retaining sleeve 50 slidably engaged onto the tool retainers 15 of the handle 10, or having a bore 51 formed therein to slidably receive the tool retainers 15. The sleeve 50 is movable relative to the tool retainers 15 (FIGS. 3-5), to force or retain the tool retainers 15 together, or to prevent the tool retainers 15 from being moved away from each other, and thus to solidly retain or couple the tool elements 40 to the tool retainers 15 of the handle 10 (FIG. 4). It is preferable that the resilient retaining sleeve 50 includes a peripheral flange 52 extended radially and outwardly therefrom to form as a hand grip 52, and to allow the sleeve 50 to be easily moved along the tool retainers 15 with the hand grip 52.

In operation, as shown in FIG. 5, when the resilient retaining sleeve 50 is slid or moved away from the outer or free end 18 of the tool retainers 15 of the handle 10, the tool retainers 15 are released and may be slightly moved toward and away from each other to allow tool elements 40 of different diameters to be easily attached thereto. After the tool elements 40 have been selectively engaged into the trapezoid depressions 17 of the tool retainers 15 or the hexagonal depression 17 of the handle 10, the sleeve 50 may then be slid or moved toward the outer or free end 18 of the tool retainers 15, in order to solidly retain the tool element 40 between the tool retainers 15.

The plates 11, 12 and the tool retainers 15 are preferably made of stronger materials, such as metal, plastic, or other synthetic materials, and the sleeve 50 is preferably made of stronger plastic or synthetic materials, to solidly force and retain the tool element 40 between the tool retainers 15.

Accordingly, the driving tool attaching device in accordance with the present invention includes a movable and resilient retaining sleeve for solidly coupling tool members to the driving shank of the driving tool.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A driving tool attaching device comprising:
a handle including two plates secured together and disposed parallel to each other, and each plate including a tool retainer extended therefrom and having a depression formed therein,
said tool retainers being disposed parallel to each other and spaced away from each other, and said depressions of said tool retainers form an engaging depression to receive a tool element therein, and
a sleeve slidably engaged onto said tool retainers, and movable relative to said tool retainers, to retain said tool retainers together, and to prevent said tool retainers from being moved away from each other, and to solidly retain the tool element between said tool retainers.

2. The driving tool attaching device as claimed in claim 1, wherein each of said tool retainers includes two side flaps extended therefrom and inclined relative to said tool retainers, to form a trapezoid depression therein, and to form said engaging depression in said tool retainers.

3. The driving tool attaching device as claimed in claim 1, wherein said sleeve includes a peripheral flange extended outwardly therefrom to form as a hand grip, and to facilitate moving of said sleeve along said tool retainers.

4. The driving tool attaching device as claimed in claim 1 further comprising a spacer disposed and secured between said plates, to space said plates from each other.

5. The driving tool attaching device as claimed in claim 4, wherein said spacer includes two side panels extended therefrom to form two recesses in upper and bottom portions thereof, and to receive said plates respectively, and to anchor said spacer between said plates.

6. The driving tool attaching device as claimed in claim 4, wherein said spacer includes a cavity formed therein for receiving a spring biased projection.

7. The driving tool attaching device as claimed in claim 1, wherein said handle includes a tool driving member attached thereto, for driving fasteners.

8. The driving tool attaching device as claimed in claim 7, wherein said tool driving member includes a barrel rotatably engaged in said handle and having an engaging hole formed therein for receiving the fasteners.

9. The driving tool attaching device as claimed in claim 7, wherein said tool driving member includes a gear disposed on an outer peripheral portion of said barrel, a pawl rotatably secured to said handle with a pivot pin, and a spring biased projection engaged with said pawl, to force said pawl to engage with said gear, and to determine a driving direction of said driving member.
